(19) United States
(12) Patent Application Publication
(10) Pub. No.: US 2010/0221504 A1
(43) Pub. Date: Sep. 2, 2010

(54) METHOD FOR PRODUCING A COMPONENT WITH A RELIEF SURFACE AND A COMPONENT OF THIS TYPE

(76) Inventor: Joerg R. Bauer, Weingarten (DE)

Correspondence Address: GREENBLUM & BERNSTEIN, P.L.C., 1950 ROLAND CLARKE PLACE, RESTON, VA, 20191, US

(21) Appl. No.: 12/600,104

(22) PCT Filed: May 7, 2008
(86) PCT No.: PCT/EP08/03673

§ 371 Date: Nov. 13, 2009

(30) Foreign Application Priority Data
May 14, 2007 (DE) 10 2007 022 919.6

(51) Int. Cl. B41J 2/01; B32B 3/10

(52) U.S. Cl. 428/195.1; 347/101

(57) ABSTRACT

In a method for producing a component with a relief surface, the relief surface is produced by printing an unfinished component (14) with a curable relief liquid by means of a digital printing method controlled by electronic data processing, wherein the electronically stored design (72) corresponding to the relief surface contains relief data assigned to two-dimensional surface elements of the relief design, which relief data correspond to the quantity of the relief liquid to be applied for each surface element.

### CROSS-REFERENCE TO RELATED APPLICATIONS

The present application is a U.S. National Stage of International Patent Application No. PCT/EP2008/003673 filed May 7, 2008, and claims priority under 35 U.S.C. §§119 and 365 of German Patent Application No. 10 2007 022 919.6 filed May 14, 2007. Moreover, the disclosure of International Patent Application No. PCT/EP2008/003673 is expressly incorporated by reference herein in its entirety.

### BACKGROUND OF THE INVENTION

1. Field of the Invention

The invention relates to a method for producing a component with a relief surface and a component with a relief surface.

2. Discussion of Background Information

The task of producing components with relief surfaces arises for a variety of applications. For example, it is advantageous for the production of components, the surface of which has the appearance of a real wood surface, to give the surface a three-dimensional structure that imitates the real wood structure embodied with grooves, holes and elevations. It is known to replicate structures of this type through the use of calender rolls and the like. These known methods on the one hand are complex to carry out and on the other hand they are not suitable for imitating the large variety of natural three-dimensional surfaces that are not repeated in the intervals of a circumference of a calender roll.

The method for producing a component with a relief surface by printing an unfinished component with a curable relief liquid via an inkjet printing method controlled by electronic data processing is known from printed publication US 2004/0189768 A1. This printed publication describes a method for producing a component with a relief surface, in which a layer with different thickness can be applied onto a base body by a print head, in that the spraying of droplets from the print head is modulated. A design is applied according to a conventional inkjet printing method onto this layer embodied with a relief of non-uniform thickness. The relief data for controlling the corresponding print head contain the three position coordinates of a respective original, i.e., the position on the surface of a respective original and a height coordinate that gives the distance from the base area.

DE 693 30 117 T2 describes a printing compound that contains an ultraviolet radiation curable resin and a filler mixed with the resin to form a paste, wherein the paste has a consistency such that when it is applied to a substrate, it forms a bead on the substrate.

U.S. Pat. No. 6,069,778 A describes a method for printing containers for housing recording media, in which the container surface is provided with an adhesive layer on which an ink-receptive layer is applied, which in turn is printed with a design. A protective coat is applied onto the design layer, wherein a region of the design layer to be labeled remains free of the protective coat. Because the distance of a print head guided above the surface to be printed from that surface is kept constant during printing, three-dimensional surfaces can also be printed.

DE 10 2006 023 117 A1 describes a method and a device for printing a substrate in which the data corresponding to a design to be printed are divided into design elements, which are respectively printed by one print head.

### SUMMARY OF THE INVENTION

The invention is directed to producing three-dimensional relief surfaces also from originals that are largely flat.

According to the invention, an electronically stored design corresponding to the relief surface contains relief data assigned to two-dimensional surface elements of the relief design, which relief data correspond to the quantity of relief liquid to be applied for each surface element, such that the relief data are produced by filtering original data. In this regard, original data, for example, data that contain a flat image, are filtered, for example, filtered according to their color, filtered according to their gray tone, filtered according to their contrast, etc. In this manner, relief surfaces can be produced which convert the spatial impression produced, for example, by shading of an image or by different colors in the image, into an actual three-dimensional quality and give it a plastic representation. The spatial impression of surfaces of this type is intensified and improved compared to the original. A scanning of the thickness contour or height contour of the original is not necessarily essential.

Further and alternative embodiments are directed at advantageous implementation forms and further developments of the method according to the invention. In particular, these further and alternative embodiments can include, e.g., that the relief data are produced by a color-filtering of the original data; that the relief data are produced by gray-scale filtering of the original data; that the relief data are produced from original data obtained by scanning an original; that thicker areas of the relief surface are produced by applying further relief liquid onto thinner relief surface areas already provided with relief liquid; that the relief data are produced from height data of an original; that the relief surface produced by inkjet printing is printed with a design by inkjet printing, the data of which design are produced from the original data; and that the relief surface printed with a design is provided with a protective coat.

Even relatively thick or high regions of a surface can easily be produced by applying further relief liquid onto thinner relief surface areas already provided with relief liquid, in that the curable relief liquid is applied in several layers one on top of the other according to the relief data. For example, intensively highlighted parts of an original or intensively colored parts of an original can be embodied with much greater thickness compared to the other regions of the original.

The invention is directed to a component with a relief surface, which is formed by multilayered coating of a surface of an unfinished component with a curable relief liquid. Thus, according to the invention, the relief surface was produced by a multilayer coating with curable relief liquid.

In the present application, a digital printing method means printing methods in which a liquid in the form of individual droplets of liquid is sprayed from at least one spray nozzle onto individual surface elements of a surface to be printed with electronic control by at least one digital data record, in order to produce a predetermined design, which can also have the appearance of a homogenous coloring, on the surface. Different colors can be produced by different color liquids that are sprayed in the form of droplets on a surface element or directly adjacent surface elements. Different color intensities can be produced by the number of the droplets reaching a surface element or directly adjacent surface elements and/or—more recently—by different volumes of the droplets of liquid. A typical example of a digital printing method is the so-called inkjet printing method, in which droplets of ink or coloring liquid are sprayed from a print head with several spray nozzles. The droplets are generated and sprayed by thermal evaporation (bubble jet) or with the aid of piezoelectric elements.

Accordingly, embodiments of the invention are directed to a method for producing a component with a relief surface. The method includes printing a relief surface on a component with a curable relief liquid. The printing is based on relief data representing two-dimensional surface elements of a relief design and a quantity of relief liquid to be applied for each of the surface elements. The relief data is produced by filtering original data.

According to other embodiments, the relief design can be stored as an electronically stored design. Further, the printing can include an inkjet printing method controlled by an electronic data processing. The electronic data processing may control the inkjet printing method to print the relief design according to the electronically stored design.

In accordance with still other embodiments of the instant invention, the component printed can be an unfinished component.

According to still other embodiments, the relief data can produced by a color-filtering of the original data. Further, the relief data can be produced by gray-scale filtering of the original data. Further still, the relief data may be produced by scanning an original.

In accordance with embodiments, thicker areas of the relief surface may be produced by applying additional relief liquid onto thinner relief surface areas already provided with relief liquid.

According to further embodiments of the invention, the relief data can be produced from height data of an original.

Moreover, the printing may include an inkjet printing method, whereby the relief surface is printed with a design produced from the original data by inkjet printing. The method can also include applying a protective coat over the printed relief surface. In embodiments, different protective liquids can be applied onto at least some different surface elements. Also in embodiments, protective liquids may be applied by inkjet printing that is controlled by protective layer data produced from the original data.

According to still other embodiments, component with a relief surface can be formed by the above-described method.

Embodiments of the invention are directed to a component that includes a surface, and a relief surface comprising multilayered coatings formed on the surface with a curable relief liquid.

In accordance with still yet other embodiments of the present invention, the surface can be an unfinished surface.

### BRIEF DESCRIPTION OF THE DRAWINGS

The invention is explained below based on diagrammatic drawings by way of example and with further details, wherein the digital printing method is referred to for the sake of simplicity as an inkjet printing method but is not restricted thereto.

They show:

FIG. 1 diagrammatically illustrates a device for producing a relief surface by printing an unfinished component with an inkjet printing method;

FIG. 2 diagrammatically illustrates a device for producing components with relief surfaces according to an original; and

FIG. 3 diagrammatically illustrates different process steps taking place in the device according to FIG. 2.

### DETAILED DESCRIPTION OF THE EMBODIMENTS

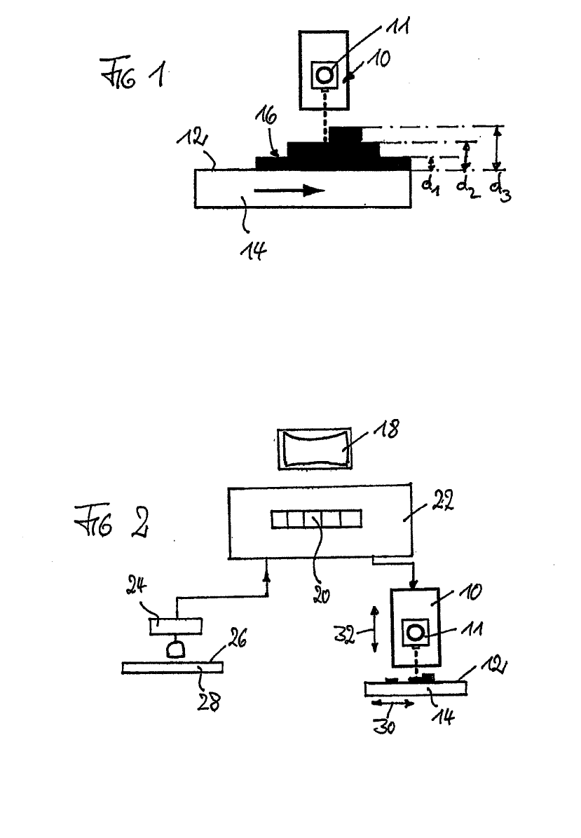

FIG. 1 shows diagrammatically an inkjet printing device 10 for inkjet printing of a surface 12 of an unfinished component 14.

The inkjet printing device is a design known per se. Droplets of coloring liquid are thereby sprayed from spray nozzles so that with precise control of a relative motion between the print head 11 provided with the nozzles and the component to be printed and by controlling the number of liquid droplets emitted by the individual spray nozzles or also the volume of the droplets of liquid, predetermined surface locations of the surface to be printed can be provided with predetermined quantities of coloring liquid. For color printing, for example, color-specific nozzles can be provided, which are loaded with coloring liquids of predetermined colors such that different colors are produced with an intensity depending on the absolute quantities of the coloring liquids on the surface depending on the relative quantity of the coloring liquids sprayed onto a surface element. The energy of the droplets of coloring liquid reaching the surface can be generated with the aid of electric heating (bubble jet) or with the aid of piezoelectric elements or by other devices. The control of the inkjet printing device 10 or the relative motion between the unfinished component 14 and the print head of the inkjet printing device 10 is carried out with the aid of an electronic control device in which data are stored corresponding to a predetermined print design to be produced on the surface 12. The structure of an inkjet printing device 10 is known per se and is therefore not explained in detail.

In contrast to a conventional inkjet printing method in which coloring liquids are applied to the surface 12, which liquids evaporate and/or penetrate into the surface and thereby leave behind color pigments, with the printing step illustrated based on FIG. 1, a printing of the surface 12 is carried out with a relief liquid which is characterized in that after drying it forms a layer with a predetermined thickness on the surface 12. In the example shown, the layer has three different thicknesses d₁, d₂, d₃, which, for example, are applied in that firstly in a first relief printing step the regions that are to have one of the thicknesses d₁, d₂ or d₃ in the finished state are printed with a layer of the thickness d₁, then the regions that are to have the thickness d₂ are printed with an additional layer so that the thickness d₂ is achieved, and in a third step the regions that are to have the thickness d₃ are printed with relief liquid in a further step. As can be easily seen from FIG. 1, a relief surface 16 with virtually any profile can be produced on the original surface 12 of the unfinished component 14 with the aid of this printing method. The number of layers that are necessary to produce a predetermined thickness depends on the respective relief liquid.

The relief liquid can be transparent or opaque and, for example, contain pigments in a high density, which form a solid layer after the solvent has dried, or can be a liquid that cures rapidly in air or under UV radiation, wherein in the latter case an ultraviolet light source is preferably integrated in the print head of the inkjet printing device 10, which ultraviolet light source ensures that the relief liquid sprayed from the print head cures quickly. One example of a relief liquid is alcohol, e.g., ethanol, which contains a binder that is soluble in alcohol and has a low viscosity in the dissolved state, e.g., Laropal® A 101 from BASF, as well as optionally particles. A liquid that is curable under UV radiation contains fatty acids, for example, and additionally particles, such as pigments. Furthermore, relief liquids can optionally be applied with separate print heads such as are used in so-called multi jet modeling. Liquids of this type are for example UV-sensitive photopolymers, which are sprayed (printed) in the form of monomers and then rapidly polymerize or harden under UV radiation.

The unfinished component 14 can be any component, the surface 12 of which in the unfinished state or optionally after a pretreatment is suitable for printing according to an inkjet printing method.

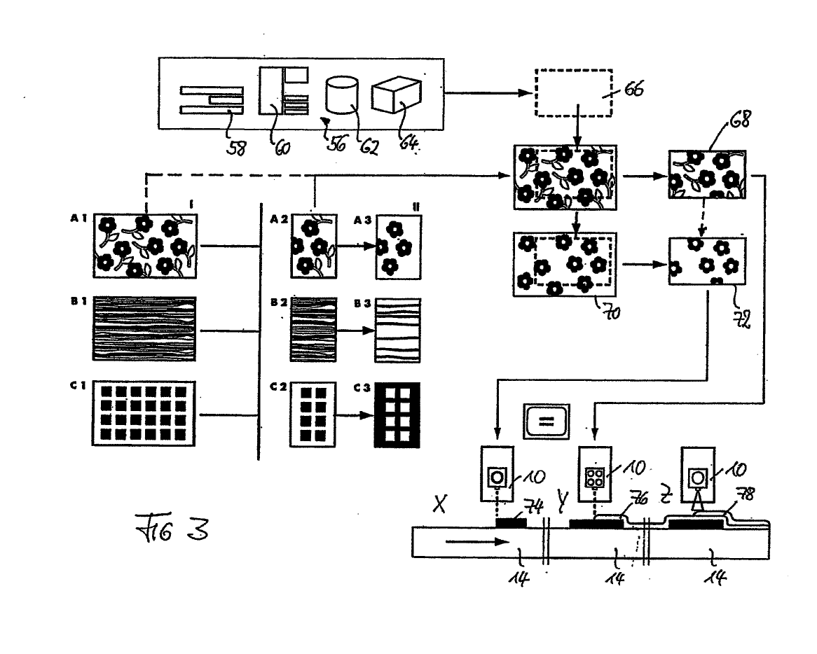

FIG. 2 shows overall a system for carrying out the connection explained in detail based on FIG. 3.

According to FIG. 2, an electronic data processing device provided, for example, with a screen 18 and operating elements 20, for example, a computer provided with a microprocessor, program storage and data storage devices, is connected to a scanning device 24 and the inkjet printing device 10.

The surface 26 of an original 28 is scanned by means of the scanning device 24, wherein, for example, not only the optical appearance of the surface 26 is recorded, but, for example, also the height profile or the relief of the surface 26 is recorded, in that the scanning device 24 contains an ultrasonic scanning head. Scanning devices of this type are known per se and are therefore not explained in detail. The scanning device is not obligatory. The data for controlling the printing device 10 can also be generated from a digital photograph or generated in a fully synthetic manner.

The data processing device 22 controls the inkjet printing device 10 in a manner known per se according to process steps that are explained below. The print head 11 contained in the inkjet printing device can be embodied as a bar that extends, for example, perpendicular to the paper plane of the FIG. 2 over the entire unfinished component 14 to be printed. It then contains, for example, several print heads that are arranged in the longitudinal direction of the printing bar overlapping one another. With a known geometric assignment between the unfinished component 14 and the print head 11 or printing bar, then only a relative motion between the print head 11 and the unfinished component 14 in the direction of the double arrow 30 as well as, if necessary, a relative motion between the unfinished component 14 and the print head 11 in the direction of the double arrow 32 is necessary.

If the print head or printing bar 11 does not extend over the entire unfinished component 14, a relative motion between the print head 11 and the unfinished component 14 perpendicular to the paper plane is necessary in addition. Devices with which relative motions of this type can be controlled precisely and the relative position between the print head and the surface 12 to be printed is recorded, are known per se and are therefore not explained.

FIG. 3 shows three different surfaces 26 of originals 28 according to FIG. 2. The upper original A1 contains a flower design, the center original B1 is a real wood surface and the lower original C1 is a geometric design.

In a step I the designs A1, B1 or C1 are scanned by the scanning device 24 and design data records A2, B2 or C2 are produced in the data processing device 22, which design data records respectively represent a defined area section from the original. The design data records can also correspond to a digital photograph or can be produced in a completely synthetic manner.

Filtered design data records A3, B3 and C3 generated from the design data records A2, B2 or C2 are labeled by A3, B3 and C3.

For example, the design data record A2 can be filtered such that in a step II a filtered design data record is produced which contains only the blossoms of the flowers. The design data record B2 can be filtered such that it contains only the very dark pattern lines of the design data record B2.

The design data record C2 of the geometric design can be filtered such that the filtered design data record C3 contains only the areas not filled with design area elements. Naturally, a variety of filters are possible, for example, color filters, gray tone filters, contrast filters, etc.

Different unfinished components are shown in the box 56 which are to be printed according to the invention, for example, parquet elements 58, front cladding elements 60, for example, for a kitchen, a cylindrical unfinished component 62 and a cube 64.

The format 66 of the surface to be printed is established depending on the unfinished component to be printed. It is assumed below that the basis for the printing is the original surface A1 patterned with flowers. When the format 66 has been established, a printing design data record 68 is produced from the design data record A2 or directly from the original surface (which can also be a digital photograph or a synthetic design), the format of which printing design data record corresponds to the format 66. If the format 66 is larger than the area covered by the design data record A2, a design data record is produced from the design data record A2 by mirroring, lining up etc., which design data record is at least as large as the format 66. If the design data record A2 covers a larger area than the format 66, the design data record 68 is produced by cutting out the design data record accordingly. A filtered design data record 70 is produced from the design data record by filtering, from which filtered design data record a filtered relief printing data record 72 is produced, which corresponds to the filtered printing design data record 68. Alternatively, the relief printing data record can be produced directly by filtering the printing design data record 68.

In a first print step X, the unfinished component 14 is subsequently provided with a relief surface using the relief printing data record 72, which relief surface in the example shown corresponds to the blossoms corresponding in the relief printing data record 72, in which the surface of the unfinished component 14 is provided with a relief layer 74.

In a second print step Y, the surface of the unfinished component 14 provided with the relief layer 74 is printed with a design layer 76, the appearance of which is established in the design printing data record 68. Since the printing design data record 68 and the relief printing data record are produced from the same design data record, it is ensured that the blossoms of the original, differentiated in terms of color or contrast, are printed precisely at those locations in which the surface is raised due to the relief layer 64. After the design printing step Y, in the example shown the relief-like surface of the unfinished component 14 printed with the design is provided with a protective coat 68 in a further print step Z to produce the fully printed component.

For the print steps X, Y and Z advantageously different print heads or printing bars are used, since the printing liquids used are different. However, a single print head or printing bar provided with a corresponding plurality of print nozzles can also be used. An ink jet printing method is not necessarily essential in the print step Z, since the surface as a whole is provided with a protective coat. When an inkjet printing method is also used in the print step Z, for example, different areas of the surface can be provided with different protective coats, for example, protective coats with a matte surface, glossy protective coats, slightly colored protective coats, etc. The corresponding data can be produced from a further filtering of the design data or, for example, can correspond to the relief printing data record 62.

The design layer 66 is shown in an exaggerated manner in FIG. 3 with regard to its thickness.

A variety of surfaces can be replicated in a manner faithful to the original with the described method according to the invention. If the original is a three-dimensional original (original with relief surface), the relief printing data record can be generated directly from a corresponding scan of the surface. Otherwise the relief printing data record can be generated based on any suitable filtering, wherein different color values, gray scales etc. can be assigned to different relief heights (thickness of the relief layer 74). For example, an oil painting with a thick application of paint can first be shown in its relief and then printed with a design according to its appearance in terms of color.

As the above demonstrates, the invention opens up a new possibility for replicating original surfaces with great precision in terms of their relief (three-dimensionality) and their appearance.

### LIST OF REFERENCE NUMBERS

10 Inkjet printing device
11 Print head
12 Surface
13 Unfinished component
16 Relief surface
18 Screen
20 Operating elements
22 Data processing device
24 Scanning device
26 Surface
28 Original
30 Double arrow
32 Double arrow
56 Box
58 Parquet element
60 Front cladding element
62 Cylindrical body
64 Cube
66 Format
68 Printing design data record
70 Filtered design data record
72 Relief printing data record
74 Relief layer
76 Design layer
78 Protective layer
A1, B1, C1 Original surface
A2, B2, C2 Design data record
A3, B3, C3 Filtered design data record
X Relief printing step
Y Design printing step
Z Protective layer printing step

1-10. (canceled)

11. A method for producing a component with a relief surface, comprising:
printing a relief surface on a component with a curable relief liquid, the printing being based on relief data representing two-dimensional surface elements of a relief design and a quantity of relief liquid to be applied for each of the surface elements,
wherein the relief data is produced by filtering original data.

12. The method in accordance with claim 11, wherein the relief design is stored as an electronically stored design.

13. The method in accordance with claim 12, wherein the printing comprises an inkjet printing method controlled by an electronic data processing.

14. The method in accordance with claim 13, wherein the electronic data processing controls the inkjet printing method to print the relief design according to the electronically stored design.

15. The method in accordance with claim 11, wherein the component printed is an unfinished component.

16. The method in accordance with claim 11, wherein the relief data is produced by a color-filtering of the original data.

17. The method in accordance with claim 11, wherein the relief data is produced by gray-scale filtering of the original data.

18. The method in accordance with claim 11, wherein the relief data is produced by scanning an original.

19. The method in accordance with claim 11, wherein thicker areas of the relief surface are produced by applying additional relief liquid onto thinner relief surface areas already provided with relief liquid.

20. The method in accordance with claim 11, wherein the relief data is produced from height data of an original.

21. The method in accordance with claim 11, wherein the printing comprises an inkjet printing method, whereby the relief surface is printed with a design produced from the original data by inkjet printing.

22. The method in accordance with claim 21, further comprising applying a protective coat over the printed relief surface.

23. The method in accordance with claim 22, wherein different protective liquids are applied onto at least some different surface elements.

24. The method in accordance with claim 22, wherein protective liquids are applied by inkjet printing that is controlled by protective layer data produced from the original data.

25. A component with a relief surface formed by the method of claim 11.

26. A component comprising:
a surface;
a relief surface comprising multilayered coatings formed on the surface with a curable relief liquid.

27. The component in accordance with claim 26, wherein the surface is an unfinished surface.
